(19) United States
(12) Patent Application Publication
(10) Pub. No.: US 2011/0161662 A1
(43) Pub. Date: Jun. 30, 2011

(54) SYSTEM AND METHOD FOR UPDATING DIGITAL CERTIFICATE AUTOMATICALLY

(75) Inventors: CHUNG-I LEE, Tu-Cheng (TW); HAI-HONG LIN, Shenzhen City (CN); GANG XIONG, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/826,673

(22) Filed: Jun. 30, 2010

(30) Foreign Application Priority Data
Dec. 30, 2009 (CN) 200910312805.9

(51) Int. Cl. H04L 29/06; H04L 9/00; H04L 9/32

(52) U.S. Cl. 713/156; 380/29; 713/168

(57) ABSTRACT

A system and method for automatically updating a digital certificate prompts a user of a client computer to update a current digital certificate if a period of validity of the current digital certificate elapses or is about to elapse, and creates a new digital certificate if the current digital certificate needs to be updated. The system and method further deletes the current digital certificate, and loads the new digital certificate into a storage system of the client computer.

### BACKGROUND

1. Technical Field

Embodiments of the present disclosure relate to digital signature technology, and particularly to a system and method for updating a digital certificate automatically.

2. Description of Related Art

A digital signature uses a digital certificate to encrypt and decrypt electronic documents. The digital certificate includes various information, such as a public key, a private key, signer information, or a period of validity of the digital certificate, for example. The various information of the digital certificate are issued by an authoritative third-party organization, such as a certificate authority (CA) server. However, the digital certificate has to be updated manually if the period of validity of the digital certificate elapses or is about to elapse within a predefined time period.

What is needed, therefore, is a system and method to overcome the aforementioned problem.

### BRIEF DESCRIPTION OF THE DRAWINGS

FIG. 1 is a block diagram of one embodiment of a system for updating a digital certificate automatically.

FIG. 2 is a block diagram of one embodiment of a client computer and a CA server in FIG. 1.

FIG. 3 is a flowchart of one embodiment of a method for updating a digital certificate automatically.

### DETAILED DESCRIPTION

All of the processes described below may be embodied in, and fully automated by, functional code modules executed by one or more general purpose computers or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

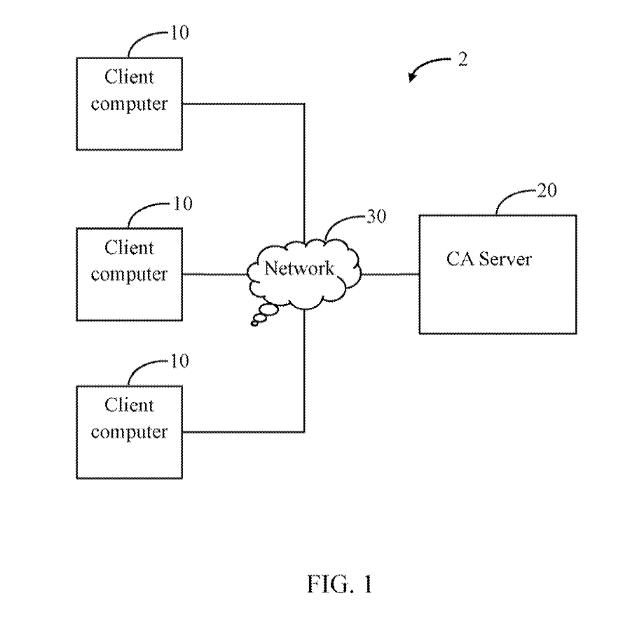

FIG. 1 is a block diagram of one embodiment of a system 2 for updating a digital certificate automatically. In some embodiments, the system 2 may be used to update a current digital certificate of a user if a period of validity of the current digital certificate elapses or is about to elapse within a predefined time period. Detailed descriptions will be given in the following paragraphs.

In some embodiments, the system 2 may include a plurality of client computers 10 and a certificate authority (CA) server 20. Each of the plurality of client computers 10 is electronically connected to the CA server 20 through a network 30. Depending on the embodiment, the network 30 may be an intranet, the Internet or other suitable communication networks.

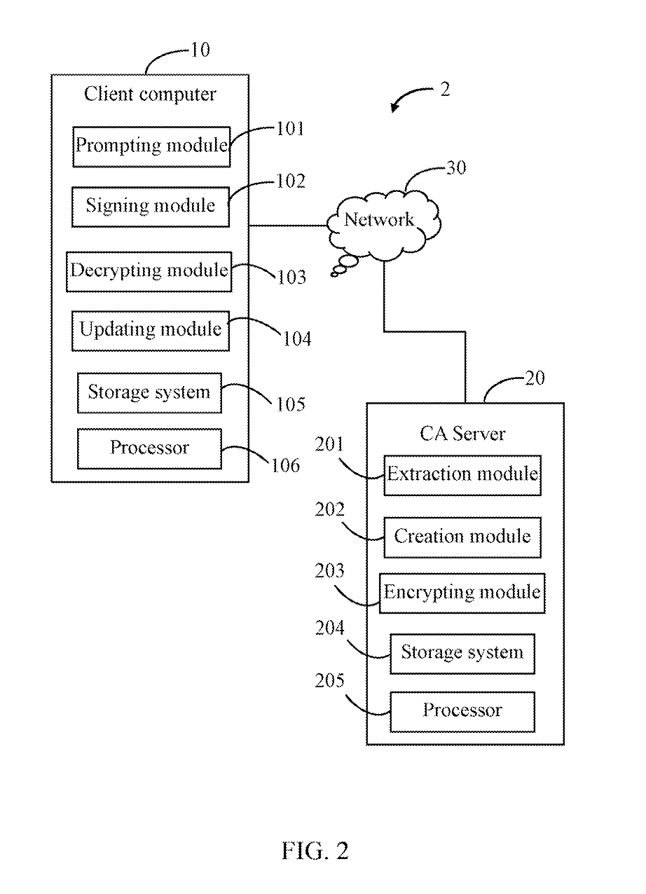

FIG. 2 is a block diagram of one embodiment of the client computer 10 and the CA server 20 in FIG. 1. In some embodiments, the client computer 10 includes a prompting module 101, a signing module 102, a decrypting module 103, an updating module 104, and a storage system (hereinafter refer to a first storage system) 105. The CA server 20 includes an extraction module 201, a creation module 202, an encrypting module 203, and a storage system (hereinafter refer to a second storage system) 204.

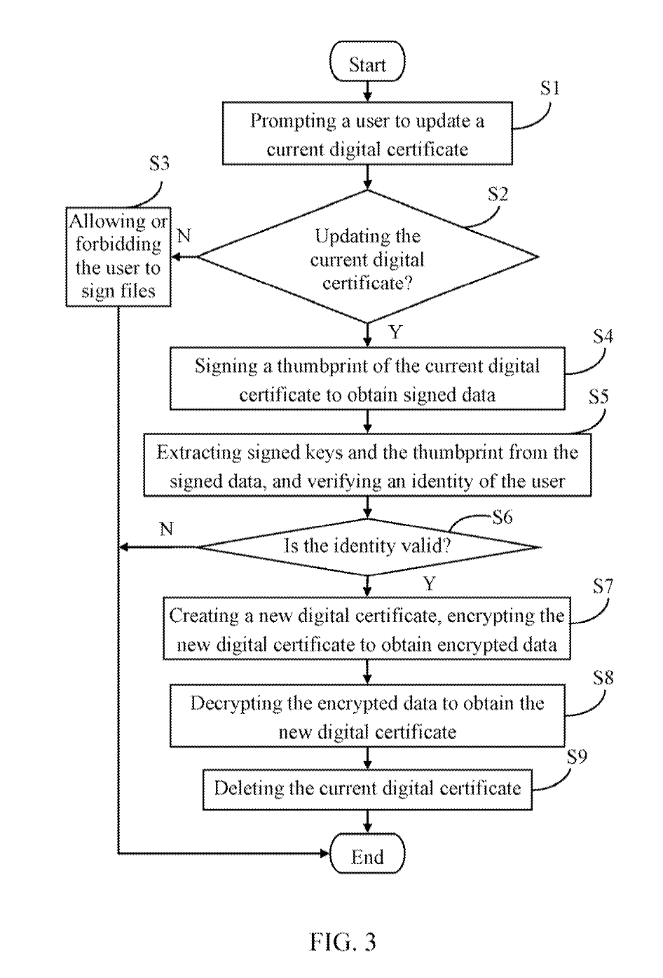

In some embodiments, the modules 101-104 comprise one or more computerized instructions that are stored in the first storage system 105, and the modules 201-203 comprise one or more computerized instructions that are stored in the second storage system 204. A processor 106 of the client computer 10 executes the computerized instructions to implement one or more operations of the client computer 10, and a processor 205 of the CA server 20 executes the computerized instructions to implement one or more operations of the CA server 20. Detailed descriptions of the function of each of the plurality of modules 101-104 and 201-203 are given in FIG. 3.

FIG. 3 is a flowchart of one embodiment of a method for updating a digital certificate automatically. Depending on the embodiment, additional blocks may be added, others removed, and the ordering of the blocks may be changed.

In block S1, the prompting module 101 prompts a user to update a current digital certificate stored in the first storage system 105 of the client computer 10 if a period of validity of the current digital certificate elapses or is about to elapse within a predefined time period (e.g., two days). In some embodiments, the prompting module 101 determines that the period of validity of the current digital certificate is about to elapse two days before the expiration time of the current digital certificate. In some embodiments, the prompting module 101 prompts the user to update the current digital certificate by outputting an alarm message on a display of the client computer 10.

In block S2, the prompting module 101 determines if the current digital certificate needs to be updated according to a selection of the user. If the current digital certificate does not need to be updated, the procedure goes to block S3. If the current digital certificate needs to be updated, the procedure goes to block S4.

In block S3, the client computer 10 allows the user to digitally sign electronic documents, or forbids the user to digitally sign electronic documents or files. For example, if the period of validity of the current digital certificate does not elapse, the client computer 10 allows the user to digitally sign electronic documents. If the period of validity of the current digital certificate elapses, the client computer 10 forbids the user to digitally sign electronic documents.

In block S4, the signing module 102 signs a thumbprint of the current digital certificate digitally to obtain signed data, and sends the signed data to the CA server 20 through the network 30. In some embodiments, the signed data may include signed keys and a thumbprint of the current digital certificate. The signed keys may include a public key of the current digital certificate. In some embodiments, the thumbprint of the current digital certificate may be a hash value to ensure that the certificate has not been tampered with by unauthorized users.

In block S5, the extraction module 201 extracts the signed keys and the thumbprint of the current digital certificate from the signed data. Then, the creation module 202 verifies an identity of the user according to the extracted signed keys and the thumbprint.

In block S6, the creation module 202 determines if the identity of the user is valid. In some embodiments, if the extracted signed keys and the thumbprint are the same as backup signed keys and thumbprint of a backup digital certificate stored in the second storage system 204 of the CA server 20, the creation module 202 determines that the identity of the user is valid, and then the procedure goes to block S7. If the extracted signed keys or the thumbprint are not the same as the backup signed keys or thumbprint of the backup digital certificate stored in the second storage system 204 of the CA server 20, the creation module 202 determines that the identity of the user is not valid, and then the procedure ends.

In block S7, the creation module 202 creates a new digital certificate. Then, the encrypting module 203 encrypts the new digital certificate according to a public key in the extracted signed keys, and sends the encrypted new digital certificate to the client computer 10 through the network 30. In some embodiments, the encrypting module 203 encrypts the new digital certificate according to the public key in the extracted signed keys by using a data encryption standard (DES) algorithm.

In block S8, the decrypting module 103 decrypts the encrypted new digital certificate according to a private key of the current digital certificate to obtain the new digital certificate.

In block S9, the updating module 104 deletes the current digital certificate, and loads the new digital certificate into the first storage system 105.

In other embodiment, the client computer 10 and the CA server 20 may be combined to form an application server or other suitable computing devices. Then, the application server accomplishes all of the tasks executed by the client computer 10 and the CA server 20.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for updating a digital certificate automatically, the method comprising:
prompting a user to update a current digital certificate if a period of validity of the current digital certificate elapses or is about to elapse within a predefined time period;
signing a thumbprint of the current digital certificate digitally to obtain signed data if the current digital certificate needs to be updated;
extracting signed keys and the thumbprint of the current digital certificate from the signed data, and verifying an identity of the user according to the extracted signed keys and the thumbprint;
creating a new digital certificate if the identity of the user is valid, encrypting the new digital certificate according to a public key in the extracted signed keys;
decrypting the encrypted new digital certificate according to a private key of the current digital certificate to obtain the new digital certificate; and
deleting the current digital certificate, and loading the new digital certificate into a storage system of the computer.

2. The method according to claim 1, further comprising: allowing the user to digitally sign electronic documents if the current digital certificate does not need to be updated upon the condition that the period of validity of the current digital certificate is about to elapse within the predefined time period.

3. The method according to claim 1, further comprising: forbidding the user to digitally sign electronic documents if the current digital certificate does not need to be updated upon the condition that the period of validity of the current digital certificate elapses.

4. The method according to claim 1, wherein the new digital certificate is encrypted according to the public key by using a data encryption standard (DES) algorithm.

5. The method according to claim 1, wherein the step of verifying an identity of the user according to the extracted signed keys and the thumbprint comprises:
determining that the identity of the user is valid if the extracted signed keys and the thumbprint are the same as backup signed keys and thumbprint of a backup digital certificate stored in the computer; and
determining that the identity of the user is not valid if the extracted signed keys or the thumbprint are not the same as the backup signed keys or thumbprint of the backup digital certificate stored in the computer.

6. A method for updating a digital certificate automatically, the method comprising:
prompting a user to update a current digital certificate if a period of validity of the current digital certificate stored in a computer elapses or is about to elapse within a predefined time period;
signing a thumbprint of the current digital certificate to obtain signed data if the current digital certificate needs to be updated, and sending the signed data to a certificate authority (CA) server;
receiving an encrypted new digital certificate from the CA server, and decrypting the encrypted new digital certificate according to a private key of the current digital certificate to obtain the new digital certificate; and
deleting the current digital certificate, and loading the new digital certificate into a storage system of the computer.

7. The method according to claim 6, further comprising: allowing the user to digitally sign electronic documents if the current digital certificate does not need to be updated upon the condition that the period of validity of the current digital certificate is about to elapse within the predefined time period.

8. The method according to claim 6, further comprising: forbidding the user to digitally sign electronic documents if the current digital certificate does not need to be updated upon the condition that the period of validity of the current digital certificate elapses.

9. A method for updating a digital certificate automatically, the method comprising:
receiving signed data generated by signing a thumbprint of a current digital certificate from a client computer, and extracting signed keys and the thumbprint of the current digital certificate from the signed data;
verifying an identity of a user according to the extracted signed keys and the thumbprint, and creating a new digital certificate if the identity of the user is valid; and
encrypting the new digital certificate according to a public key in the extracted signed keys, and sending the encrypted new digital certificate to the client computer for updating the current digital certificate.

10. The method according to claim 9, wherein the new digital certificate is encrypted according to the public key by using a data encryption standard (DES) algorithm.

11. The method according to claim 9, wherein the step of verifying an identity of the user according to the extracted signed keys and the thumbprint comprises:
determining that the identity of the user is valid if the extracted signed keys and the thumbprint are the same as backup signed keys and thumbprint of a backup digital certificate; and
determining that the identity of the user is not valid if the extracted signed keys or the thumbprint are not the same as the backup signed keys or thumbprint of the backup digital certificate.

12. A computer for updating a digital certificate automatically, the computer comprising:
a storage system operable to store a current digital certificate of a user;
a prompting module operable to prompt the user to update the current digital certificate if a period of validity of the current digital certificate elapses or is about to elapse within a predefined time period;
a signing module operable to sign a thumbprint of the current digital certificate to obtain signed data if the current digital certificate needs to be updated, and send the signed data to a certificate authority (CA) server;
a decrypting module operable to receive an encrypted new digital certificate sent from the CA server, decrypt the encrypted new digital certificate according to a private key of the current digital certificate to obtain the new digital certificate; and
an updating module operable to delete the current digital certificate, and load the new digital certificate into a storage system of the computer.

13. The computer according to claim 12, wherein the prompting module further operable to: allow the user to digitally sign electronic documents if the current digital certificate does not need to be updated upon the condition that the period of validity of the current digital certificate is about to elapse within the predefined time period.

14. The computer according to claim 12, wherein the prompting module further operable to: forbid the user to digitally sign electronic documents if the current digital certificate does not need to be updated upon the condition that the period of validity of the current digital certificate elapses.

15. A computer for updating a digital certificate automatically, the computer comprising:
a storage system operable to store a backup digital certificate of a user;
an extraction module operable to receive signed data generated by signing a thumbprint of a current digital certificate from a client computer, and extract signed keys and the thumbprint of the current digital certificate from the signed data;
a creation module operable to verify an identity of a user according to the extracted signed keys and the thumbprint, and create a new digital certificate if the identity of the user is valid; and
an encrypting module operable to encrypt the new digital certificate according to a public key in the extracted signed keys, and send the encrypted new digital certificate to the client computer for updating the current digital certificate.

16. The computer according to claim 15, wherein the new digital certificate is encrypted according to the public key by using a data encryption standard (DES) algorithm.

17. The computer according to claim 15, wherein the creation module verifies an identity of the user according to the extracted signed keys and the thumbprint by:
determining that the identity of the user is valid if the extracted signed keys and the thumbprint are the same as backup signed keys and thumbprint of a backup digital certificate stored in the computer; and
determining that the identity of the user is not valid if the extracted signed keys or the thumbprint are not the same as the backup signed keys or thumbprint of the backup digital certificate stored in the computer.
